(19) United States
(12) Patent Application Publication
(10) Pub. No.: US 2018/0039411 A1
(43) Pub. Date: Feb. 8, 2018

(54) Method and Apparatus for Providing Data Storage and Network Communication Using an Auxiliary Plug

(71) Applicant: Ross Stenfort, Los Altos, CA (US)

(72) Inventor: Ross Stenfort, Los Altos, CA (US)

(73) Assignee: CNEX Labs, Inc., San Jose, CA (US)

(21) Appl. No.: 15/666,094

(22) Filed: Aug. 1, 2017

Related U.S. Application Data
(60) Provisional application No. 62/370,194, filed on Aug. 2, 2016.

(51) Int. Cl. G06F 3/06; G06F 13/42; G06F 13/40

(52) U.S. Cl. CPC G06F 3/061; G06F 3/0679; G06F 3/0655; G06F 13/4081; G06F 13/4282

(57) ABSTRACT

A non-volatile memory (“NVM”) solid state drive (“SSD”) auxiliary (“NSA”) plug, capable of providing bridge function and memory storage, is structured in a small form-factor pluggable (“SFP”) or quad small form-factor pluggable (“QSFP”) configuration. In one aspect, an SFP auxiliary plug (“SAP”) or NSA plug includes an Ethernet connector, NVM storage, bridge component, and memory controller. The Ethernet connector is pluggable to an Ethernet socket situated at a network system for data transmission. The NVM storage can store information persistently. The bridge component facilitates protocol conversion capable of converting data formatted between Ethernet protocol and a serial bus protocol for network communication. The memory controller is able to route data traffic between an output port of NSA plug and the NVM storage.

### PRIORITY

This application claims the benefit of priority based upon U.S. Provisional Patent Application having an application Ser. No. 62/370,194, filed on Aug. 2, 2016, and having a title of “Method and Apparatus for Providing Data Storage Embedded in Auxiliary Plugs,” which is hereby incorporated by reference in its entirety.

### FIELD

The exemplary embodiment(s) of the present invention relates to the field of semiconductor and integrated circuits. More specifically, the exemplary embodiment(s) of the present invention relates to non-volatile memory (“NVM”) solid state drive (“SSD”) auxiliary plug or SFP auxiliary plug (“SAP”) able to provide bridge and storage function.

### BACKGROUND

With increasing popularity of electronic devices, such as computers, smart phones, mobile devices, server farms, mainframe computers, and the like, the demand for more and faster data is constantly growing. To handle and facilitate voluminous data between various devices, NVM devices which can store data persistently are typically required. A conventional type of NVM device, for example, is a flash based storage device such as, for example, an SSD.

A flash based SSD, for example, is an electronic NVM storage device capable of maintaining, erasing, and/or reprogramming data. The flash memory can be fabricated with several different types of integrated circuit (“IC”) technologies such as NOR or NAND logic gates with, for example, floating-gate transistors. Depending on the applications, the organization of a flash based SSD can be in blocks, pages, words, and/or bytes.

A problem associated with a traditional SSD device is that it typically requires connection cables, connectors, and/or sockets.

### SUMMARY

An SFP auxiliary plug (“SAP”), NVM SSD auxiliary (“NSA”) plug, or SFP NVM SSD (“SNS”) plug capable of providing bridge and/or storage functions, is structured in a small form-factor pluggable (“SFP”) or quad small form-factor pluggable (“QSFP”) configuration. In one aspect, the SAP includes an Ethernet connector, NVM storage, bridge component, and memory controller. The Ethernet connector is pluggable to an Ethernet socket situated at a network system for data transmission. The NVM storage can store information persistently. The bridge component facilitates protocol conversion capable of converting data formatted between Ethernet protocol and serial bus protocol for network communication. Alternatively, the bridge component is able to convert between Ethernet data format and optical data format. The memory controller is able to facilitate and/or route data traffic between an output port of SAP or NSA plug for network communication and the NVM storage for data storage.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1A is a block diagram illustrating an SAP or NSA plug configured to provide communication bridge as well as data storage via a standard coupling connector in accordance with one embodiment of the present invention;

FIGS. 1B-5B show block diagrams illustrating exemplary SAPs able to provide Ethernet bridge as well as embedded storage in accordance with one embodiment of the present invention;

FIG. 6 is a block diagram illustrating an exemplary computing system capable of coupling to multiple SAPs or auxiliary plugs for providing various different functions concurrently in accordance with one embodiment of the present invention;

FIGS. 7A-7B are block diagrams illustrating a configuration of NVM including flash translation layer (“FTL”) used in SAP memory in accordance with one embodiment of the present invention;

FIG. 8 is a physical diagram illustrating an SFP or quad SFP (“QSFP”) host printed circuit board (“PCB”) in accordance with one embodiment of the present invention;

FIGS. 9-10 illustrate physical structures relating to SFP and/or QSFP mechanical outline dimensions in accordance with one embodiment of the present invention;

FIG. 11 is a diagram illustrating a computer network capable of providing network routing between users using an SFP/QSFP storage device including SAP in accordance with one embodiment of the present invention;

FIG. 12 is a block diagram illustrating a digital processing system capable of using an auxiliary storage device in accordance with one embodiment of the present invention; and

FIG. 13 is a flowchart illustrating an SAP process of providing data storage as well as data transmission in accordance with one embodiment of the present invention.

### DETAILED DESCRIPTION

Embodiments of the present invention are described herein with context of a method and/or apparatus for providing a small auxiliary pluggable device capable of performing functions of network communication and data storage.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

One exemplary embodiment of the present invention discloses an NSA, SAP, SNS plug capable of facilitating network communication as well as data storage. In one example, the auxiliary plug is structured in an SFP or quad SFP (“QSFP”) configuration. The SAP or NSA plug includes an Ethernet connector, NVM storage, bridge component, and memory controller. The Ethernet connector, in one embodiment, is pluggable into an Ethernet socket which may be situated at a network system for data transmission. The memory controller is configured to optionally store the data received from the network system at a local or embedded memory. Alternatively, the memory controller can pass the data to the bridge component without storing the data first. The bridge component is able to convert the data from the data formatted in Ethernet protocol to the data formatted in Universal Serial Bus (USB) protocol. Alternatively, the bridge component is able to convert between Ethernet data format and optical data format. The memory controller is able to facilitate and/or route data traffic between an output port of NSA plug for network communication and the NVM storage for data storage.

It should be noted that the terms “SAP,” “NSA,” and “SNS” refer to similar or the same small auxiliary plug in compliance with SFF standards, such as SFP, QSFP, SFP+, SFP28, compact SFP, SFP/SFP+, or the like. To simplify the forgoing discussion, SAP is primarily used in place of NSA and SNS.

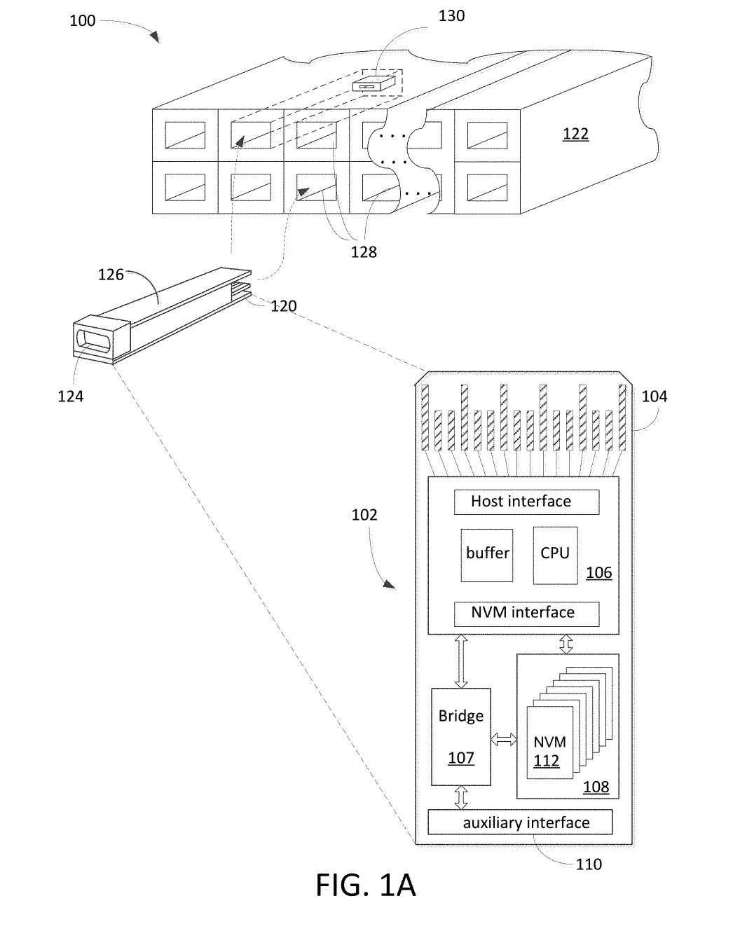

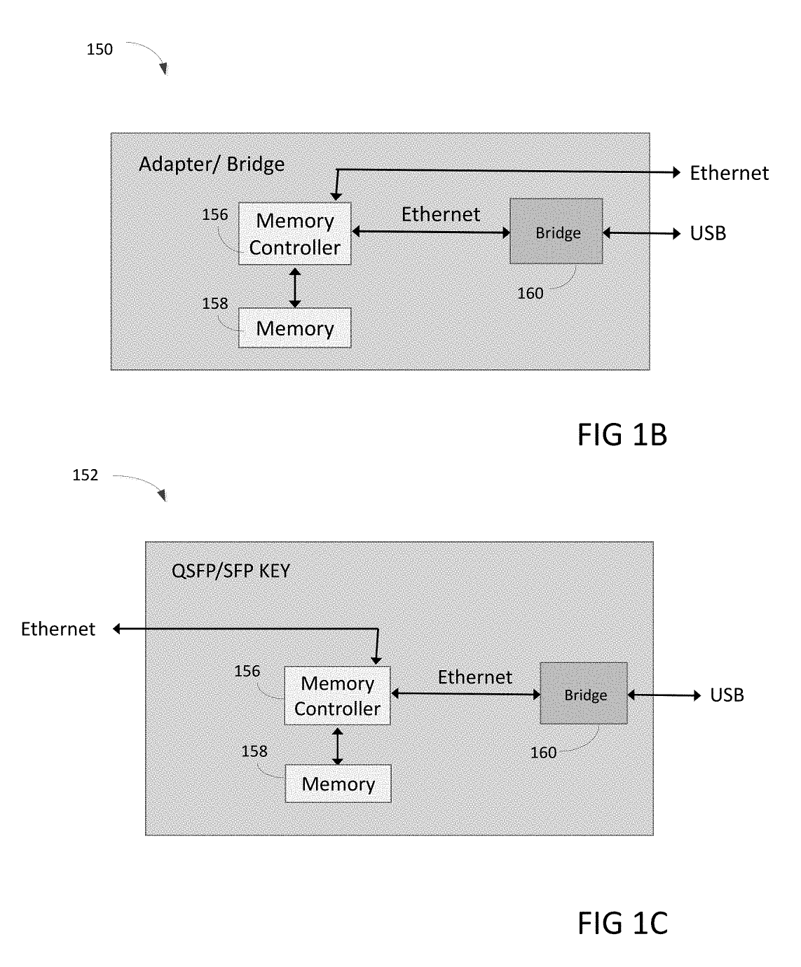

FIG. 1A is a block diagram 100 illustrating an SAP configured to provide communication bridge as well as data storage via a standard coupling connector in accordance with one embodiment of the present invention. Diagram 100 includes a digital processing system 122 and SAP 126 wherein digital processing system 122, in one example, can be a server, host, network router, network switch, base station, computer, mainframe computer, and the like. A function of digital processing system 122 is that it is able to execute instructions, storing data, and transmitting information via a network. It should be noted that the underlying concept of the exemplary embodiment(s) of the present invention would not change if one or more blocks (or devices) were added to or removed from diagram 100.

Digital processing system 122, in one example, can be a network router which includes multiple ports 128 used for network communications. A network router, for example, includes a group of ports physically configured in small form factor sockets such as SFP or QSFP sockets. Each SFP socket, for instance, includes a connector 130 which is used to electrically couple to connector of a plug. A function of SFP socket, in one example, is to facilitate storing data and/or transmitting data.

SFP format is generally relating to small size pluggable transceiver used for data communications. It should be noted that the form factor and electrical interface are standard defined by a multi-source agreement (“MSA”) under the SFF (small form factor) committee. An application of such SFP is to facilitate network communication between optical data and electrical data. For instance, SFP transceivers support various communication methods, such as, but not limited to, SONET, gigabit Ethernet, Fibre Channel, and other communications standards.

SAP 126, in one embodiment, has a front side 120 and back side 124 wherein front side 120 and back side 124 are connected by a printed circuit board (“PCB”) 102. PCB 102, in one aspect, includes a connector 104, memory controller 156, bridge 107, NVM 158, and auxiliary interface or auxiliary connector 110. While connector 104 can be used to connect a socket connector or socket contact 130, memory controller 156, also known as controller, includes a host interface module, CPU, buffer, and NVM interface. NVM 158, in one example, includes one or more NVM dies having a storage range from 64 GB to 512 TB. Auxiliary interface 110, in one aspect, is used to provide extended storage capacity. Alternatively, auxiliary interface 110 can also be used to couple to a second SFP plug, secondary power supply, or optical SFP transceiver.

Bridge or bridge component 107 is used to facilitate performing a function of transmitting network traffic between connector 104 and auxiliary interface 110. In one aspect, component 107 is configured to convert data formats for preparing and facilitating network transmission. For example, bridge component 107 is able to convert data format between USB protocol and Ethernet protocol.

In operation, SAP 126 can be inserted into any one of SFP sockets 128 at a digital processing system 122 wherein front side 120 of SFP plug 126 enters an SFP socket 128 to reach connector 130. After handshaking initialization between SAP 126 and digital processing system 122, digital processing system 122 can access NVM 108 via SAP 126. In one example, digital processing system 122 views SAP 126 as a high-speed external storage memory for storing data.

FIG. 1B is a block diagram illustrating an SAP 150 able to provide bridge and storage functions using embedded NVM storage in accordance with one embodiment of the present invention. SAP 150 includes a memory controller 156, memory 158, bridge 160, Ethernet connector, and USB connector. Bridge 160 can also be referred to as adapter capable of facilitating network communication. For example, SAP 150, containing memory controller 156, memory 158, and bridge component 160, facilitates data transmission between the Ethernet connector and USB connector. It should be noted that the underlying concept of the exemplary embodiment(s) of the present invention would not change if one or more blocks (or devices) were added to or removed from diagram 150.

SAP 150, in one embodiment, is structured or fabricated into a small or compact configuration that is capable of directly coupling to the back panel of a system. For example, SAP 150 can be structured in a USB based SFF (small form factor) configured to couple to a USB socket located at the back panel of the system or another adapter. The system (not shown in FIG. 1B), including digital processing unit, memory, communication element, and user interface, can be a network router, switch, hub, computer, smart phone, portable device, smart car, and the like.

The Ethernet connector, in one example, includes a female Ethernet connector capable of receiving a male Ethernet plug or connector. The Ethernet connector can be, but not limited to, RJ45 connector, HDMI (high definition multimedia interface), DVI (Digital Visual Interface), Thunderbolt™, USB, and the like.

Memory controller 156, in one embodiment, is coupled to memory 158 and bridge component 150, and contains firmware such as flash translation layer (“FTL”) table to manage memory 158 for storing and retrieving stored data at memory 158. In one aspect, memory 158 can be volatile, nonvolatile, or a combination of volatile and/or nonvolatile memory. For example, volatile memory includes DRAM and/or SRAM which is a type of computer memory that requires power to maintain stored data. The nonvolatile memory includes ROM (read-only memory) flash memory, F-RAM (ferroelectrical RAM), optical discs, hard disk drive (HDD) and the like that do not require power to sustain stored data.

Bridge component 160, in one embodiment, is a converter capable of translating data between Ethernet protocol and USB protocol whereby the data can be transmitted between Ethernet port(s) and USB port(s). In one aspect, bridge component 160 is coupled to memory controller 156 which manages the timing of data transmission between Ethernet port and USB port. For example, memory controller 156 is capable of deciding whether the incoming data from the Ethernet port should be stored in memory 158 or should be passed onto bridge component 160 for transmission.

During an operation, upon receipt of incoming information from an Ethernet port, memory controller 156 is able to store the incoming information at memory 158 if the incoming information is labeled or addressed for storage. Alternatively, memory controller 156 can pass the incoming information directly to bridge component 160 for conversion as well as transmission if the incoming information is labeled or addressed for transmission. Also, memory controller 156 can temporarily store incoming data at memory 158, and subsequently forward the stored incoming data to bridge component 160 for transmission. In addition, memory controller 156 can also transmit and store data simultaneously.

In one aspect, SAP 150 which is capable of facilitating data transmission as well as data storage includes an Ethernet connector, NVM storage 158, bridge component 160, memory controller 156, and USB connector. The Ethernet connector is configured to be pluggable to an Ethernet socket which can be situated at the back panel of a network system for data transmission. Bridge 160, in one example, is able to facilitate protocol conversion capable of converting data formatted between Ethernet protocol and a serial bus protocol. The USB connector, in one example, is a USB socket coupled to bridge 160 and configured to transmit data formatted in USB protocol between the USB socket and the Ethernet socket.

Memory controller 156 is configured to route data traffic between an output port of SAP 150 and NVM storage 158. In one example, memory controller 156 is able to detect a second network device which is coupled to the USB socket via a USB connector. Memory controller 156 is further configured to draw power from an attached system such as the network system via an Ethernet connector. Alternatively, memory controller 156 can draw power from a USB socket which is connected to a USB device. Furthermore, memory controller 156 can manage drawing power from an external power source or a portable power source.

NVM storage 158 can store information persistently wherein the storage can be flash based NVM. Alternatively, NVM storage 158 can be phase change memory (“PCM”). In one example, NVM storage 158 can also include volatile memory capable of buffering data transmission between Ethernet connector and bridge component 160.

Ethernet connector is a registered jack 45 (“RJ45”) plug. Alternatively, Ethernet connector can be an SFP plug. It should be noted that SAP 150 can be physically structured in SFP or QSFP. SAP 150 is a SFP NVM SSD storage device capable of storing data. In one aspect, SAP 150 includes an SFP housing which houses NVM storage 158, bridge component 160, and memory controller 156 configured to be fabricated with thermal conductive material capable of dissipating heat for SAP.

FIG. 1C is a block diagram illustrating an SAP 152 having a QSFP pluggable form factor capable of providing bridge and storage function using embedded storage in accordance with one embodiment of the present invention. SAP 152 includes memory controller 156, memory 158, bridge 160, Ethernet connector, and USB connector. SAP 152 is similar to SAP 150 except that the physical structure of SAP 152 is structured in a QSFP or SFP key form factor. It should be noted that the Ethernet port can either be a male Ethernet connector or a female Ethernet connector. Similarly, the USB port is either be a male USB connector or female USB connector.

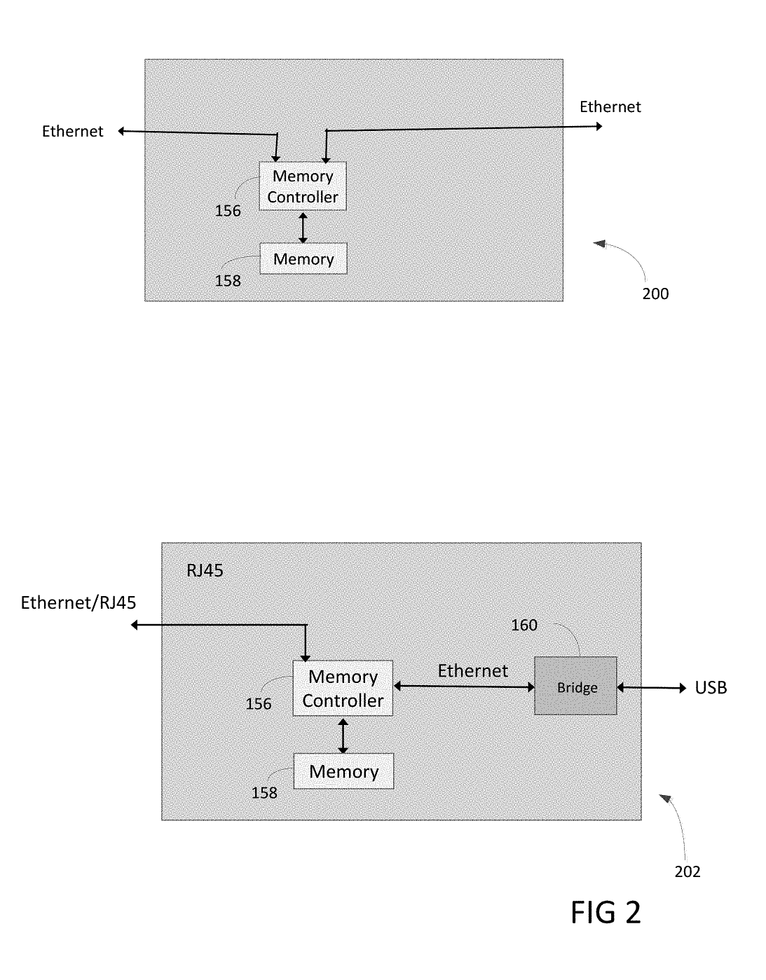

FIG. 2 shows block diagrams 200-202 illustrating alternative configuration of SAP or storage adapter capable of facilitating data communication and/or data storage in accordance with one embodiment of the present invention. Diagram 200 illustrates an SAP or auxiliary plug or in-band storage extension configured to provide flexibility of device connections. In one embodiment, the SAP or storage extension includes a memory controller 156, memory 158, and two Ethernet ports. SAP is able to provide data transmission between connected systems such as router and switches for data transmission. It should be noted that the underlying concept of the exemplary embodiment(s) of the present invention would not change if one or more blocks (or devices) were added to or removed from diagram 200.

An advantage of employing the extension auxiliary plug or SAP is that it provides additional storage capacity without requiring additional port(s). Another advantage of using the extension auxiliary plug is that it is able to dissipate heat generated by the embedded electronics such as memory 158 and controller 156.

Diagram 202 is similar to diagram 200 except that diagram 202 contains a bridge component 160. In one aspect, the Ethernet connector is an RJ45 connector while the other connector is a USB connector which could also be USB 2.0 or USB 3.0 connector. In one example, bridge component 160 is able to convert signals or data between Ethernet protocols and USB protocols (including USB 2.0 or USB 3.0 standards). The SAP, adapter, or auxiliary plug as illustrated in diagrams 200-202 can be directly inserted or plugged into a system or another auxiliary plug. A function of auxiliary plug is to provide in-band pass through Ethernet based storage adapter. Note that the auxiliary plug can be structured in any suitable configurations, such as small form factor, small dongle, SFP, QSFP, and the like.

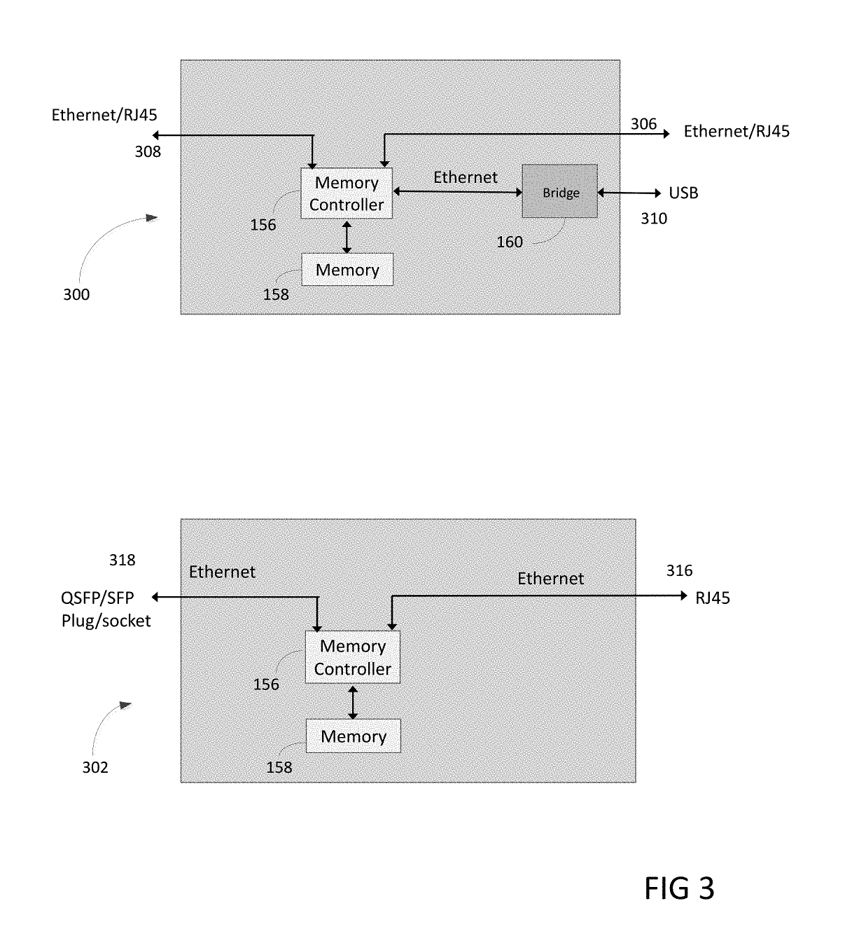

FIG. 3 shows block diagrams 300-302 illustrating alternative configuration of SAP capable of facilitating data communication and/or data storage via in-band storage in accordance with one embodiment of the present invention. Diagram 300 is similar to diagram 202 shown in FIG. 2 except that diagram 300 illustrates an additional Ethernet connector 306. Ethernet connector 306, in one example, is an RJ45 connector capable of facilitating data path between Ethernet connector 306 and Ethernet connector 308. Memory controller 156, in one embodiment, is able to facilitate data flow or data packets traveling between ports 306-310. Memory controller 156 can also be configured to store data in memory 158 from either port 306 or port 310.

It should be noted that auxiliary plug as illustrated in diagram 300 is configured to facilitate in-band storage that can be accessed by Ethernet or USB. In-band storage, in one example, is a storage process capable of transporting data or data traffic to output port 318 upon receiving a traffic stream from Ethernet port 316. Alternative, memory controller 156 is able to store data in memory 158 while the data is traveling from input port 316 to output port 318 via memory controller 156. Depending on the applications, protocol conversion for data may or may not be required.

In operation, upon receiving a data stream or data traffic from Ethernet port 308, memory controller 156 identifies whether the data stream is for storage, Ethernet transmission, and/or USB transmission. If the data is for storage, the data stream is stored in memory 158. If the data is for Ethernet transmission with no conversion required, the data stream is passed to Ethernet output port 306 via a RJ45 connector. If the data is for USB transmission and conversion is required, the data steam is forwarded to USB output port 310 after protocol conversion. If the data is for storage, USB transmission, and Ethernet transmission, the data stream is first stored in memory 158 and after protocol conversion, the data stream is forwarded to both Ethernet output ports 306 and USB output port 310.

Diagram 302 is similar to diagram 300 except that bridge component 160 is removed and port 318 is configured in compliance with QSFP or SFP. It should be noted that auxiliary plug as illustrated in diagram 302 is configured to facilitate in-band storage that can be accessed by Ethernet. In-band storage, in one example, is a storage process capable of transporting data or data traffic to output port 318 upon receiving a traffic stream from Ethernet port 316. Alternative, memory controller 156 is able to store data in memory 158 while the data is traveling from input port 316 to output port 318 via memory controller 156. In an alternative embodiment, memory 158 can be extended to external memory storage using a cable.

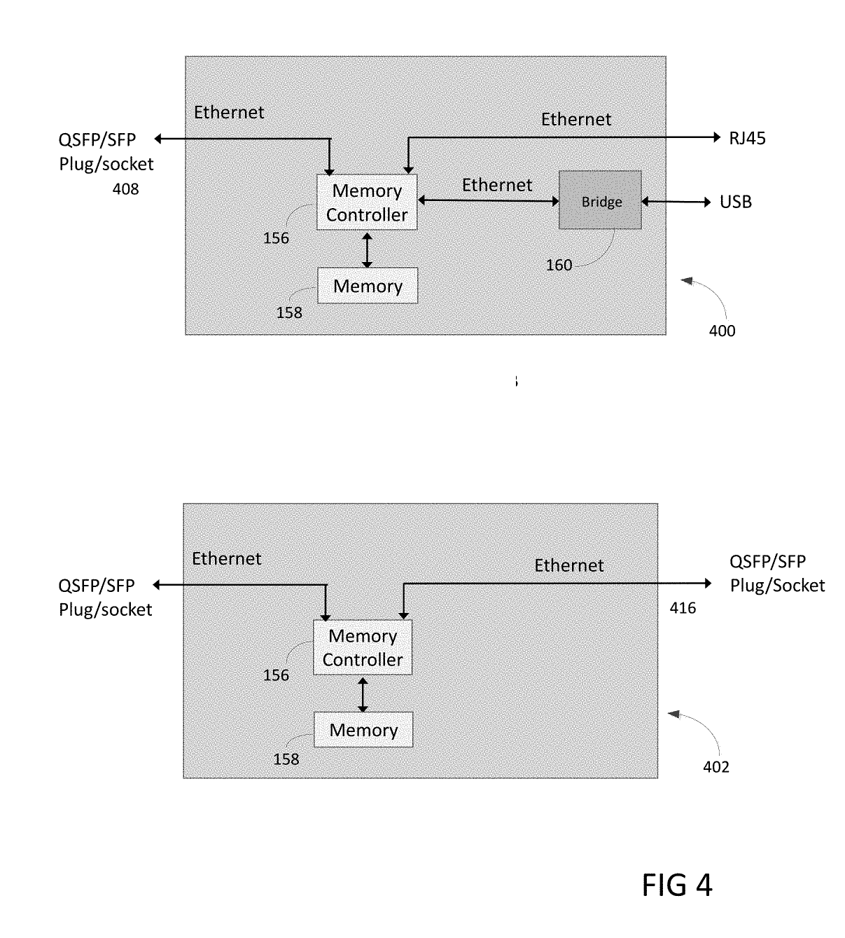

FIG. 4 shows block diagrams 400-402 illustrating alternative configuration of SAP configured to be SFP or QSFP capable of facilitating data communication and/or data storage in accordance with one embodiment of the present invention. Diagram 400 is similar to diagram 300 shown in FIG. 3 except that port 408 is configured to be in compliance with QSFP or SFP coupling standard. The plug is able to facilitate in-band storage that can be accessed by Ethernet or USB. Diagram 402 is similar to diagram 302 shown in FIG. 3 except that port 416 is configured to be in compliance with QSFP or SFP coupling standard. The plug is able to facilitate in-band storage that can be accessed by Ethernet. In one example, SAP can be considered as a cable containing storage capacity.

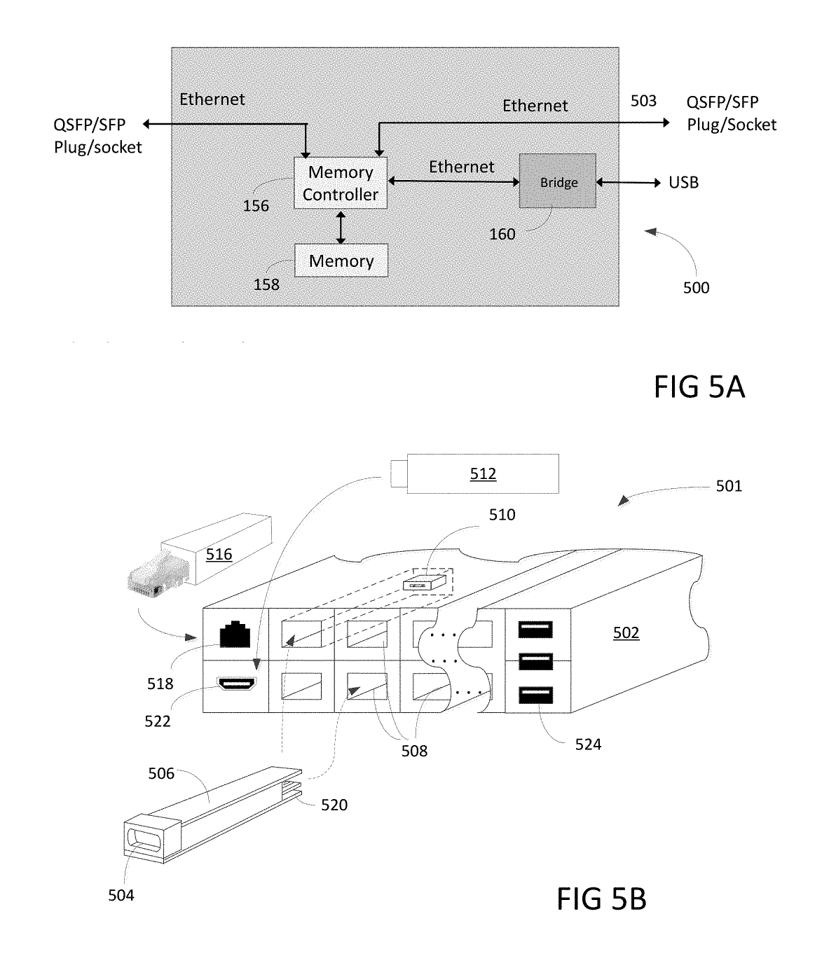

FIG. 5A is a block diagram 500 illustrating alternative configuration of SAP configured in SFP, QSFP, and/or USB capable of facilitating data communication and/or data storage in accordance with one embodiment of the present invention. Diagram 500 is similar to diagram 400 except that port 503 is configured to be in compliance with QSFP or SFP coupling standard. The plug is able to facilitate in-band storage that can be accessed by Ethernet. In one aspect, the SAP can be structured as a part of cable that contains memory storage accessible by USB or Ethernet connectors.

FIG. 5B is a block diagram 501 illustrating a system capable of coupling to multiple different auxiliary plugs or SAPs in accordance with one embodiment of the present invention. Diagram 501 includes a system 502, QSFP/SFP auxiliary plug 506, HDMI auxiliary plug 512, and RJ45 auxiliary plug 516. In one aspect, system 502 includes various ports including RJ45 port 518, HDMI ports 522, QSFP/SFP ports 508, and USB ports 524. It should be noted that the underlying concept of the exemplary embodiment(s) of the present invention would not change if one or more blocks (or devices) were added to or removed from diagram 501.

In one aspect, auxiliary plug 516 is pluggable to port 518 of system 502 via RJ 45 coupling standard, and auxiliary plug 512 is pluggable to port 522 of system 502 via HDMI coupling standard. System 502, which can be a router, switch, modem, server, hub, et cetera, includes multiple ports 508 which can be SFP sockets or QSFP sockets capable of hosting SFP devices 506. It should be noted that SFP or QSFP device 506 can also be referred to as QSPF, SFP, SFP+ modules, devices, and/or plugs. SFP or QSFP device 506, in one embodiment, is an SFP auxiliary plug capable of supplying power to neighboring SFP devices via a second connector 504. The first connector 520 of SFP device 506 is used to couple to a connector 510 in a port such as, for example, female SFP connector located at system 502.

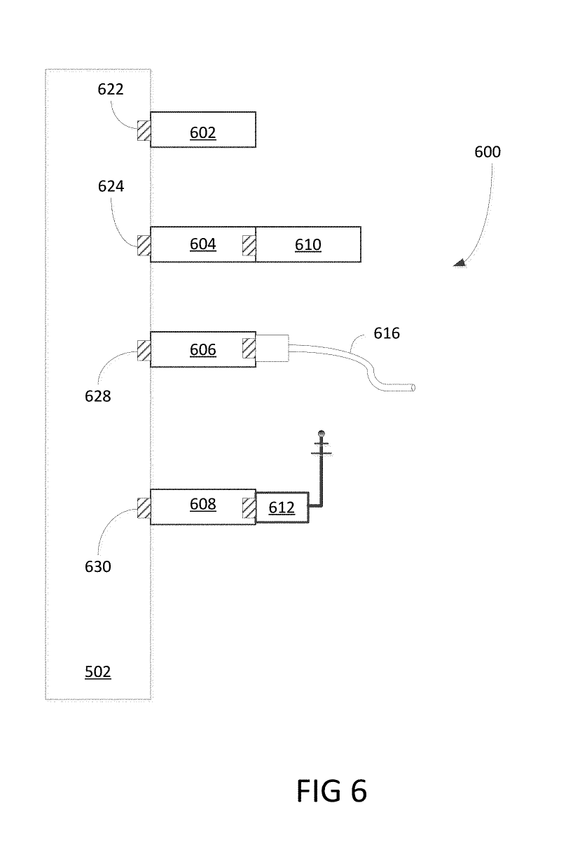

FIG. 6 is a block diagram 600 illustrating an exemplary computing system capable of coupling to multiple SAPs or auxiliary plugs for providing various different functions concurrently in accordance with one embodiment of the present invention. Diagram 600 illustrates system 502 coupled with multiple auxiliary plugs 602-608 via system ports 622-630. In one aspect, auxiliary plug 602 provides additional memory capacity to system 502. Alternatively, auxiliary plug or SAP 604 may provide power to plug 610. Also, auxiliary plug 604 may also dissipate heat generated by plug 610. Auxiliary plug or SAP 606, in one embodiment, provides buffering function for a network connections and/or communication. In one aspect, SAP 606 couples to an optical fiber 616 capable of providing communication between optical fiber 616 and system port 628. Auxiliary plug 608 is coupled to another auxiliary plug 612 which contains a function of wireless transmission and/or broadcasting. In one aspect, auxiliary plug 608 provides a buffering function for the wireless signals before transmitting to system 502.

In addition to data transmission, SAPs 602-608 contain memory storage capable of storing data. SAPs 602-608 can store data, transmit data, or store and transmit data concurrently. It should be noted that if the auxiliary plug can be used for network traffic, data storage, and/or information buffering, large memory capacity of NVM or VM (volatile memory) may be required.

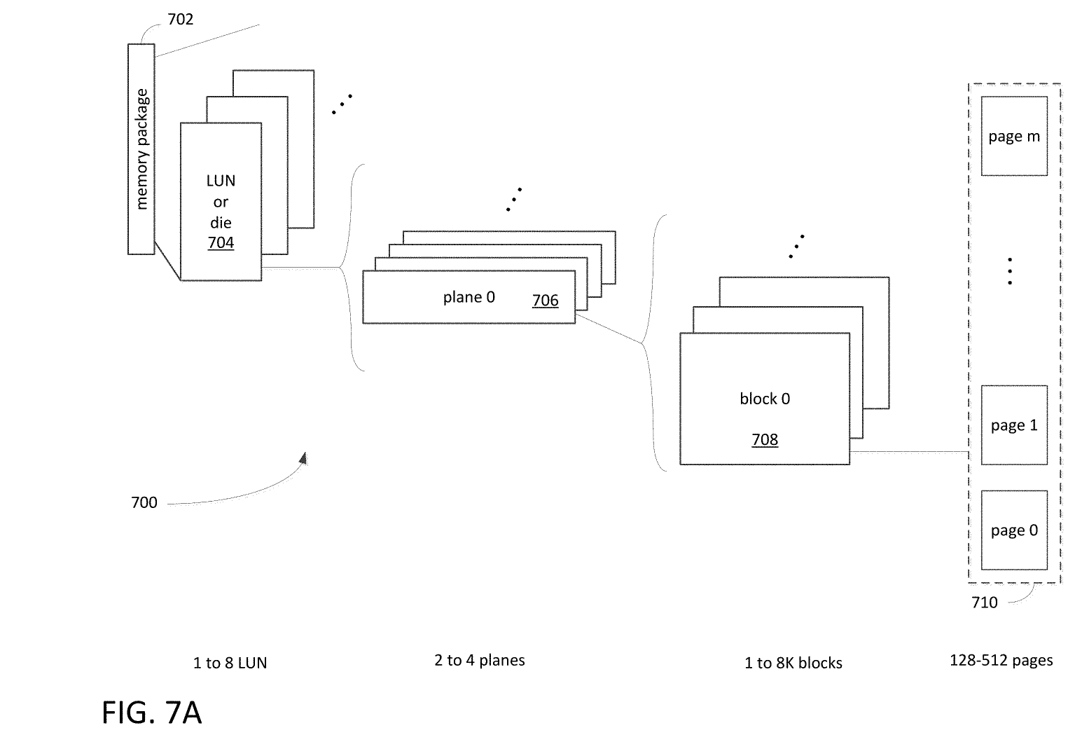

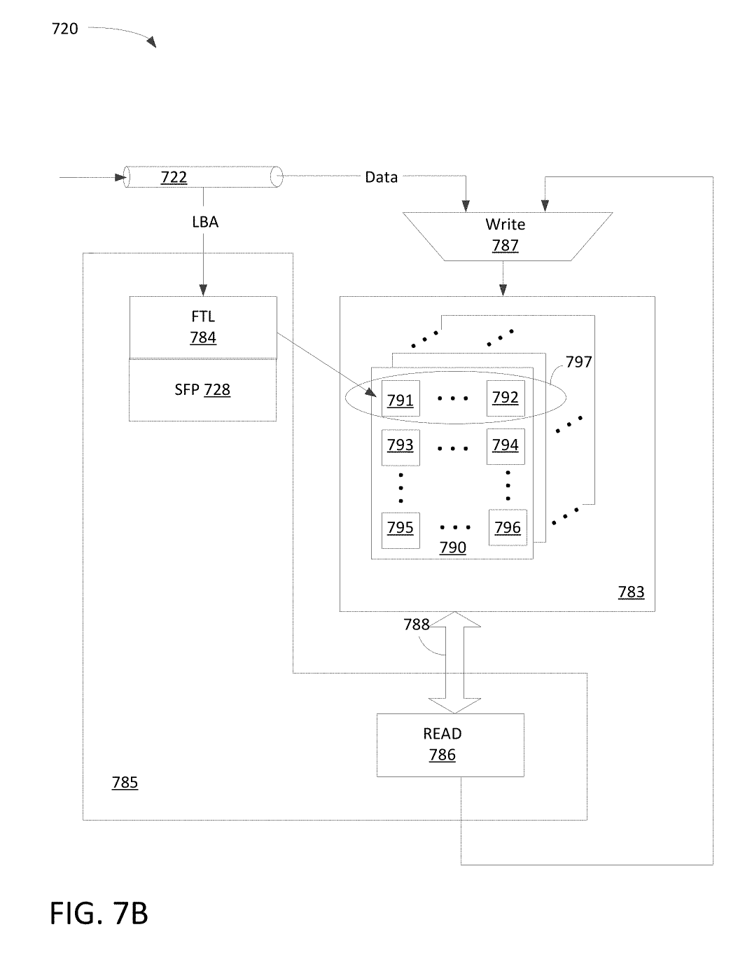

FIG. 7A is a block diagram 700 illustrating a configuration of NVM including flash translation layer (“FTL”) used in SAP memory such as memory 158 shown in FIG. 1B in accordance with one embodiment of the present invention. Diagram 700 includes a memory package 702 which can be a memory chip containing one or more NVM dies or logic units (“LUNs”) 704. A flash memory, for example, has a hierarchy of Package-Silicon Die/LUN-Plane-Block-Flash Memory Page-Word line configuration(s). It should be noted that the underlying concept of the exemplary embodiment(s) of the present invention would not change if one or more blocks (or devices) were added to or removed from diagram 700.

NVM memory device such as a flash memory package 702 contains one or more flash memory dies or LUNs wherein each LUN or die 704 is further organized into more NVM or flash memory planes 706. For example, die 704 may have a dual planes or quad planes. Each NVM or flash memory plane 706 can include multiple memory blocks or blocks. In one example, plane 706 can have a range of 1000 to 8000 blocks 708. Each block such as block 708 can have a range of 64 to 1024 pages. For instance, a flash memory block can have 256 or 1024 pages as indicated by numeral 710.

A flash memory page, for example, can store data from 8 Kbytes (kilobytes) to 64 Kbytes of data plus extra redundant area for ECC parity data to be stored. One flash memory block is the minimum unit of erase. One flash memory page is the minimum unit of program. To avoid marking an entire flash memory block bad or defective which will lose anywhere from 256 to 1024 flash memory pages, a page removal or decommission can be advantageous. It should be noted that 4 Megabytes (“MB”) to 16 MB of storage space can be saved to move from block decommissioning to page decommissioning.

Note that based on flash memory characteristics, a relatively small number of flash memory pages can usually be defective or become bad or unusable when the flash memory page PE (program erase) cycles, for example, are getting higher. For example, the bad page during program or read operation of that flash memory page can be discovered. A bad page can also be discovered if that page has much higher read errors during the normal read work load. A bad page can be further discovered when that page is bad and other pages in the same block are good.

SAP is configured in compliance with SFF coupling standards which offer high-speed, physical compactness, and versatility of utilizing existing networking sockets for storage. For example, such SFF connectors are used by switches and routers for transmitting electrical as well as optical information. An advantage of using SAP is hot-swappable.

FIG. 7B is a block diagram 720 illustrating a configuration of NVM including flash translation layer (“FTL”) used in SAP memory such as memory 158 shown in FIG. 1B in accordance with one embodiment of the present invention. Diagram 720 includes input data 722, storage device 783, output port 788, and storage controller 785. Storage controller 785 further includes read module 786, FTL 784, SFP module 728, and/or write module 787. A function of FTL 784 is, for example, to map LBA to physical address(s). It should be noted that the underlying concept of the exemplary embodiment(s) of the present invention would not change if one or more blocks (or devices) were added to or removed from diagram 720.

SFP module 728, which could be part of FTL 784, is configured to implement and/or facilitate SSD functions in SAP. For example, SFP module 708 is responsible to communicate with host(s) using small form factor connection. Also, SFP module 728 facilitates the handshaking process between SAP and host upon initial connection.

Storage device 783, in one example, includes a flash memory based NVM used in SSD. The flash memory cells are organized in multiple arrays for storing information persistently. The flash memory, which generally has a read latency less than 100 microseconds (“μs”), can be organized in logic units (“LUN”), planes, blocks, and pages. A minimum access unit such as read or write operations, for example, can be set to a page or NAND flash page which can be four (4) Kbyte, eight (8) Kbyte, or sixteen (16) Kbyte memory capacity depending on the flash memory technology employed. A minimum unit of erasing used NAND flash memory is generally set to be a block or NVM block at a time. An NVM block, in one example, can contain from 512 to 2048 pages.

Referring back to FIG. 7B, storage device 783 is organized into multiple NVM blocks 790 wherein each block such as block 790 further includes a set of pages 791-796. Each page such as page 791 has a capacity or size capable of storing 4096 bytes or 4 Kbyte of information. Each block such as block 790, in one example, may contain a range of pages from 128 to 512 pages (or sectors) 791-796. A page, in one example, is generally a minimal writable or readable unit while a block is a minimal number to perform an erase function. Flash memory 783 can persistently retain information or data for a long period of time without power supply.

FTL 784, which may be implemented in DRAM, includes a FTL database or table that stores mapping information. For example, the size of FTL database is generally a positive proportion to the total storage capacity. For instance, one way to implement the FTL in SSD is that it uses a DRAM size that approximately equals to 1/1000 of SSD capacity. Since each page has a 4-Kbyte capacity and each entry of FTL database has a 4-byte capacity of entry, the size of FTL database can be calculated as SSD capacity /4KByte*4Byte (SSD capacity/1000) which is approximately 1 over 1000 (or 1/1000).

In operation, upon receipt of data input or data packets 702, FTL 784 maps LBA to physical page address (“PPA”) in storage device 783. After identifying PPA, write circuit 787 writes the data from data packets 782 to a page or pages within a block pointed by PPA. In one aspect, SFP 728 allocates or divides storage space into basic storage units wherein the storage capacities for the basic storage units are essentially the same or similar.

It should be noted that storage device 783 can also include NAND flash memory, NOR flash memory, phase change memory (“PCM”), nano random access memory (“NRAM”), magneto-resistive RAM (“MRAM”), resistive random-access memory (“RRAM”), programmable metallization cell (“PMC”), magnetic storage media (e.g., hard disk, tape), optical storage media, or the like. To simplify the forgoing discussion, the flash memory or flash memory based SSD is herein used as an exemplary NVM or NV storage device.

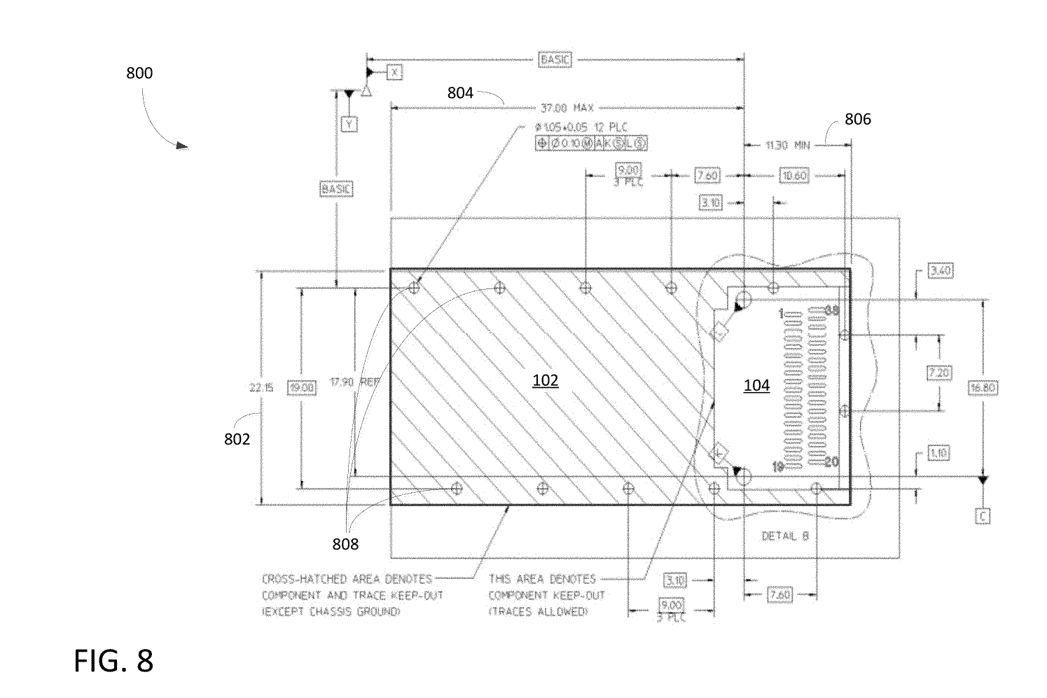

FIG. 8 is a physical diagram 800 illustrating an SFP or quad SFP (“QSFP”) host printed circuit board (“PCB”) 102 used in SAP in accordance with one embodiment of the present invention. PCB 108 as shown in FIG. 1A includes connector 104 and multiple anchoring holes 808. Diagram 800 illustrates an exemplary dimension for PCB 102. For example, the width of PCB 102 is 22.15 mm (millimeter) and the length of PCB 102 is 48.30 mm as indicated by numerals 804-806. It should be noted that the dimension for SFP is approximately 8.5 mm in height (“H”), 13.4 mm in width (“W”), and 56.5 mm in depth (“D”). While the approximate dimension for XSFP is 8.5 mm in H, 18.4 mm in W, and 78.0 mm in D, the approximate dimension for QSFP can be 13.5 mm in H, 18.4 mm in W, and 72.4 mm in D. It should be noted that the underlying concept of the exemplary embodiment(s) of the present invention would not change if one or more blocks (or measurements) were added to or removed from diagram 800.

In one embodiment, PCB 102 illustrates exemplary mechanical layout for SFP or QSFP storage device. The SFP or QSFP, in one example, is a closely packaged device having a pluggable connector which is used for hot-pluggable component. For instance, network transceivers used for both telecommunication and data communications applications are configured in SFP and/or QSFP. The small compact shape (or small form factor) and electrical/optical interface are specified by a multi-source agreement (“MSA”). For example, SFP transceivers may be for SONET, gigabit Ethernet, Fibre Channel, and other communications standards. The QSFP is also used for Ethernet, Fibre Channel, InfiniBand and SONET/SDH standards. Also, QSFP+ports are usually used for serial attached SCSI, Ethernet, QDR and FDR Infiniband, and the like.

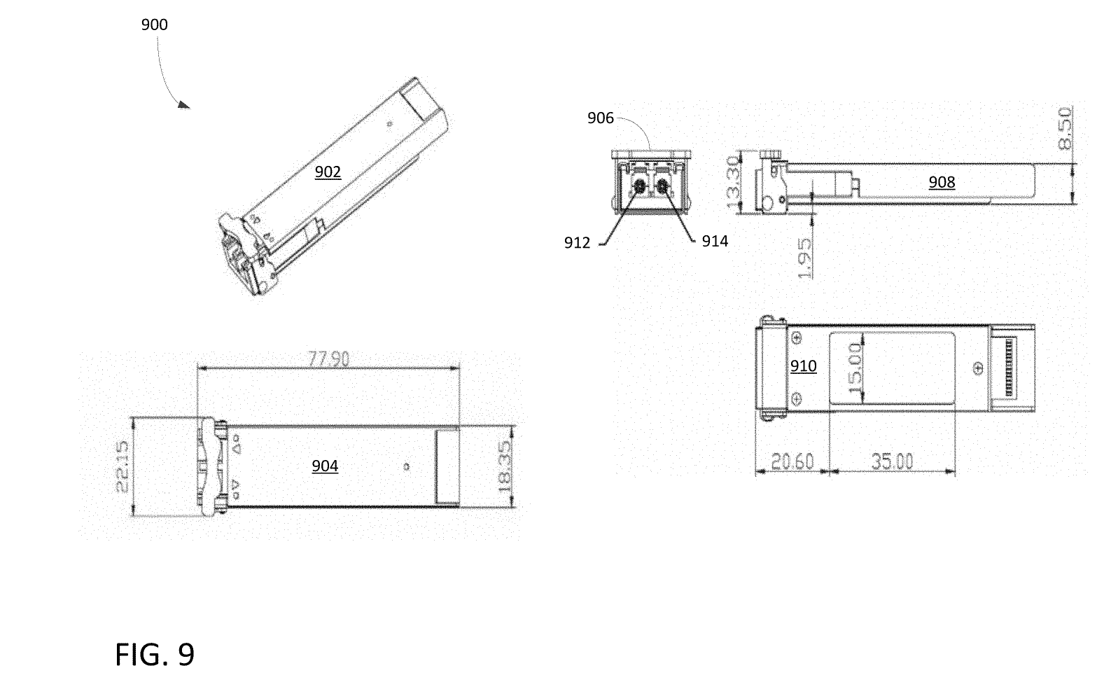

FIG. 9 illustrates SAP 900 showing several structural diagrams 902-910 of SAP relating to SFP and/or QSFP mechanical outline dimensions in accordance with one embodiment of the present invention. Diagram 902 illustrates a three dimensional (“3D”) structural diagram showing an SAP. Diagram 904 illustrates a top view of SNS plug with dimensions. Diagram 906 illustrates a back view of SAP containing two connectors 912-914 which can be used for extension of additional connections. Diagram 908 is a side view of SNS plug with dimensions. Diagram 910 is a top view of SAP with connectors. FIG. 9 shows different views of SFP or QSFP housings, cages, and/or sockets. It should be noted that the dimensions shown in FIG. 9 are for illustrative purposes. Any other dimensions with different configuration can be used to house SAP or SFP NVM storage device.

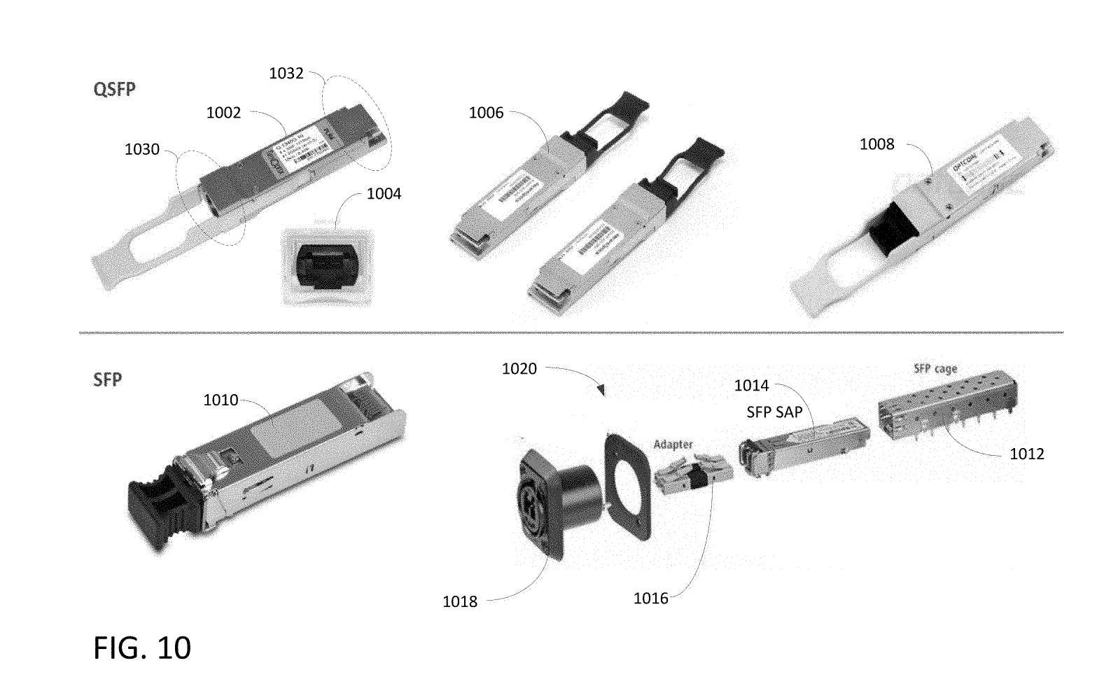

FIG. 10 illustrates exemplary 3D pictorial QSFP SAP diagrams 1002-1008 and SFP SAP 1010 in accordance with one embodiment of the present invention. In one embodiment, QSFP SAP or SFP SAP contains at least two connectors situated at two ends of QSFP SAP 1002 as indicated by numeral 1030-1032. For example, connector 1032 of QSFP SAP 1002 can be used to directly couple to a host device such as routers or switches while other connector 1030 of QSFP SAP 1002 may be used to connect to another device via a cable or wire. Diagram 1004 shows a front face of QSFP SAP diagram capable of coupling to another device or cable.

In one embodiment, QSFP SAP capable of storing data and transmitting data traffic includes an Ethernet connector, NVM storage, wireless USB manager, and memory controller. The Ethernet connector is configured to be pluggable to an Ethernet socket situated at a network system such as a router for data transmission. The NVM storage coupled to the Ethernet connector is configured to store information persistently. The wireless USB manager is able to receive and transmit data formatted in wireless protocol and facilitate data traffic to and from the Ethernet connector. The memory controller is configured to forward the data traffic from the Ethernet connector to the NVM storage or the USB manager in response to control signals in the header portion of data traffic.

Diagram 1010 illustrates an SFP SAP capable of handling data storage as well as data transmission. Diagram 1020 illustrates an SFP assemble including SFP cage 1012, SFP SAP 1014, transceiver adapter 1016, and optical cover 1018. In one example, SFP cage 1012 is located at a host system which is capable of receiving SFP SAP 1014. Adapter 1016, in one example, is able to receive two optical fibers. It should be noted that the underlying concept of the exemplary embodiment(s) of the present invention would not change if one or more blocks (or devices) were added to or removed from diagram 1020.

In one embodiment, SFP SAP 1010 capable of storing data as well as transmitting data traffic includes an Ethernet connector, NVM storage, optical convertor, and memory controller. The Ethernet connector is configured to be pluggable to an Ethernet socket situated at a network system such as a switch for data transmission. The NVM storage can store information persistently. The optical convertor is configured to convert data between optical signals and electrical signals. The memory controller is able to forward data traffic from the Ethernet connector to the NVM storage or the optical convertor in response to control signals in the header of data traffic.

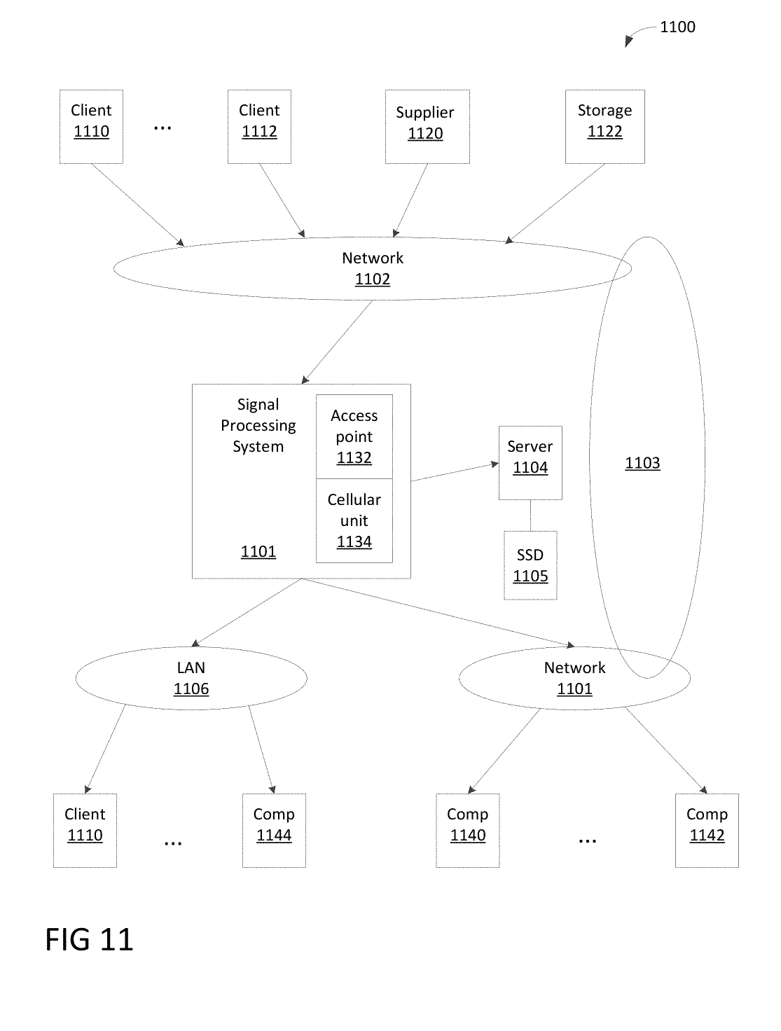

FIG. 11 is a diagram illustrating a computer network capable of providing network routing between users using an SFP/QSFP storage device including SAP in accordance with one embodiment of the present invention. In this network environment, a system 1101 is coupled to a wide-area network 1102, LAN 1106, Network 1101, and server 1104. Wide-area network 1102 includes the Internet, or other proprietary networks including America On-Line™, SBC™, Microsoft Network™, and Prodigy™. Wide-area network 1102 may further include network backbones, long-haul telephone lines, Internet service providers, various levels of network routers, and other means for routing data between computers.

Server 1104 is coupled to wide-area network 1102 and is, in one aspect, used to route data to clients 1110-1112 through a local-area network (“LAN”) 1106. Server 1104 is coupled to SFP/QSFP SDD storage device 1105 wherein the storage controller is able to decommission or logically remove defective page(s) from a block to enhance overall memory efficiency. In one aspect, an SFP auxiliary plug is used to provide additional power supply to SSD storage device 1105.

The LAN connection allows client systems 1110-1112 to communicate with each other through LAN 1106. Using conventional network protocols, USB portable system 1130 may communicate through wide-area network 1102 to client computer systems 1110-1112, supplier system 1120 and storage device 1122. For example, client system 1110 is connected directly to wide-area network 1102 through direct or dial-up telephone or other network transmission lines. Alternatively, clients 1110-1112 may be connected through wide-area network 1102 using a modem pool.

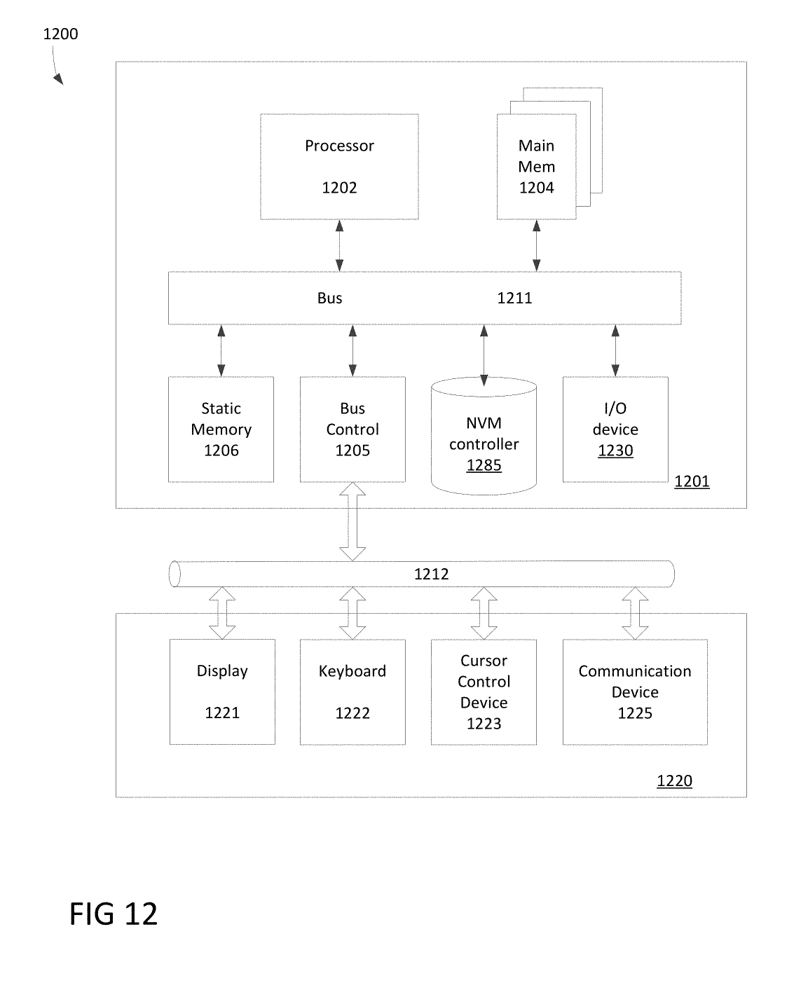

Having briefly described one embodiment of the computer network in which the embodiment(s) of the present invention operates, FIG. 12 illustrates an example of a computer system 1200, which can be an auxiliary plug, server, a router, a switch, a node, a hub, a wireless device, or a computer system.

FIG. 12 is a block diagram illustrating a digital processing system capable of using an SFP/QSFP SDD storage device/plug with one or more SAPs in accordance with one embodiment of the present invention. Computer system or a signal separation system 1200 can include a processing unit 1201, an interface bus 1212, and an input/output (“TO”) unit 1220. Processing unit 1201 includes a processor 1202, a main memory 1204, a system bus 1211, a static memory device 1206, a bus control unit 1205, an I/O element 1230, and a NVM controller 1285. It should be noted that the underlying concept of the exemplary embodiment(s) of the present invention would not change if one or more blocks (circuit or elements) were added to or removed from FIG. 12.

Bus 1211 is used to transmit information between various components and processor 1202 for data processing. Processor 1202 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 1204, which may include multiple levels of cache memories, stores frequently used data and instructions. Main memory 1204 may be RAM (random access memory), MRAM (magnetic RAM), or flash memory. Static memory 1206 may be a ROM (read-only memory), which is coupled to bus 1211, for storing static information and/or instructions. Bus control unit 1205 is coupled to buses 1211-1212 and controls which component, such as main memory 1204 or processor 1202, can use the bus. Bus control unit 1205 manages the communications between bus 1211 and bus 1212. Mass storage memory or SSD 106, which may be a magnetic disk, an optical disk, hard disk drive, floppy disk, CD-ROM, and/or flash memories are used for storing large amounts of data.

I/O unit 1220, in one embodiment, includes a display 1221, keyboard 1222, cursor control device 1223, and communication device 1225. Display device 1221 may be a liquid crystal device, cathode ray tube (“CRT”), touch-screen display, or other suitable display device. Display 1221 projects or displays images of a graphical planning board. Keyboard 1222 may be a conventional alphanumeric input device for communicating information between computer system 1200 and computer operator(s). Another type of user input device is cursor control device 1223, such as a conventional mouse, touch mouse, trackball, or other type of cursor for communicating information between system 1200 and user(s).

Communication device 1225 is coupled to bus 1211 for accessing information from remote computers or servers, such as server 104 or other computers, through wide-area network 102. Communication device 1225 may include a modem or a network interface device, or other similar devices that facilitate communication between computer 1200 and the network. Computer system 1200 may be coupled to a number of servers via a network infrastructure such as the infrastructure illustrated in FIG. 11.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

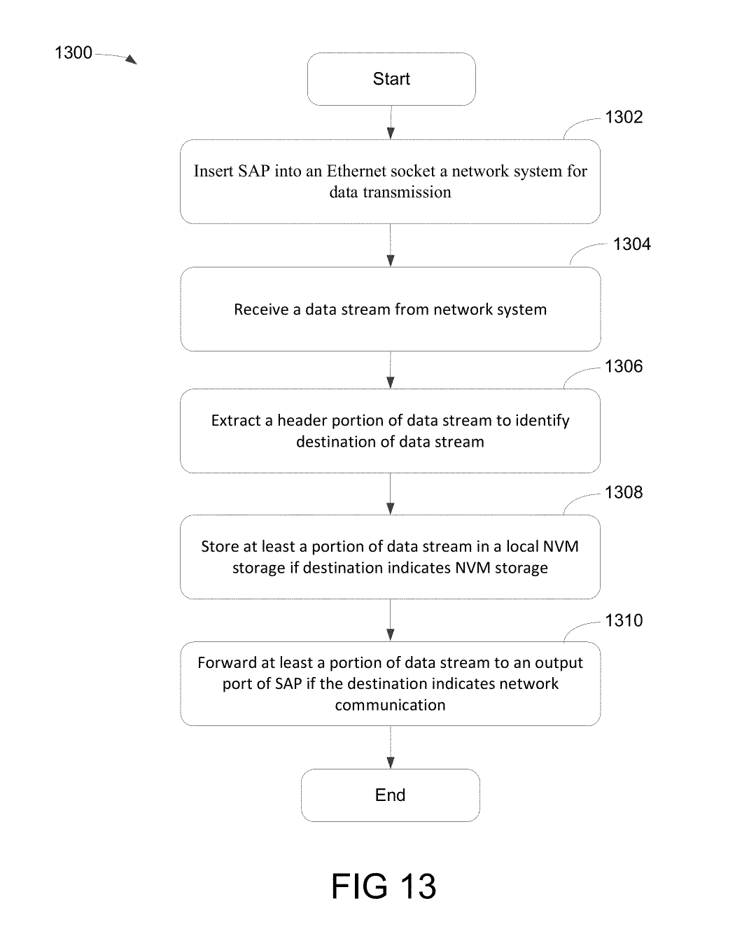

FIG. 13 is a flowchart 1300 illustrating an SAP process of providing data storage as well as data transmission in accordance with one embodiment of the present invention. At block 1302, a process is able to insert an SAP into an Ethernet socket at a network system for data transmission. After receiving a data stream from the network system via the Ethernet socket at block 1304, a header portion of the data stream at block 1306 is extracted to identify destination of the data stream. At block 1308, at least a portion of the data stream is stored in a local NVM storage if the destination of the data stream indicates NVM storage. At block 1310, at least a portion of the data stream is forwarded or transmitted to an output port of SAP if the destination of the data stream indicates network communication. In one embodiment, the data stream is converted from the USB protocol to Ethernet protocol before the data is forwarded. In one example, an optical cable is plugged into an auxiliary connector of the SAP for receiving and transmitting optical signals. In another aspect, the process is able to store at NVM storage and transmit the data stream concurrently.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. An auxiliary plug able to store data comprising:
an Ethernet connector configured to be pluggable to an Ethernet socket situated at a first network system for data transmission;
a non-volatile memory (“NVM”) storage coupled to the Ethernet connector and configured to store information persistently;
a bridge component coupled to the Ethernet connector and able to facilitate protocol conversion capable of converting data formatted between Ethernet protocol and a serial bus protocol; and
a memory controller coupled to the Ethernet connector and configured to route data traffic between an output port of the auxiliary plug and the NVM storage.

2. The plug of claim 1, further comprising a universal serial bus (“USB”) socket coupled to the bridge and configured to transmit data formatted in USB protocol between the USB socket and the Ethernet socket.

3. The plug of claim 2, wherein the memory controller detects a second network device coupled to the USB socket via a USB connector.

4. The plug of claim 1, wherein the NVM storage is a flash based non-volatile memory.

5. The plug of claim 1, wherein the NVM storage includes volatile memory capable of buffering data transmission between the Ethernet connector and the bridge component.

6. The plug of claim 1, wherein the Ethernet connector is a registered jack 45 (“RJ45”) plug.

7. The plug of claim 1, wherein the Ethernet connector is a small form-factor pluggable (“SFP”) plug.

8. The plug of claim 1, wherein the memory controller draws power from the first network system via the Ethernet connector.

9. The plug of claim 1, wherein the memory controller draws power from a universal serial bus (“USB”) socket connected to a USB device.

10. The plug of claim 1, wherein the memory controller draws power from an external power source.

11. The plug of claim 1, wherein the memory controller draws power from a portable power source.

12. The plug of claim 1, where the plug is structured in a small form-factor pluggable (“SFP”) physical structure.

13. The system of claim 1, further comprising a housing which houses the NVM storage, the bridge component, and memory controller, configured to be fabricated with thermal conductive material capable of dissipating heat for the plug.

14. The system of claim 1, a small form-factor pluggable (SFP) non-volatile memory (NVM) solid state drive (SSD) storage device capable of storing data comprising the plug of claim 1.

15. A small form-factor pluggable (“SFP) plug for storing data and transmitting data traffic, comprising:
an Ethernet connector configured to be pluggable to an Ethernet socket situated at a first network system for data transmission;
a non-volatile memory (“NVM”) storage coupled to the Ethernet connector and configured to store information persistently;
an optical convertor coupled to the NVM storage and configured to convert data between optical signals and electrical signals; and
a memory controller coupled to the Ethernet connector and configured to forward data traffic from the Ethernet connector to the NVM storage or the optical convertor in response to control signals in header of the data traffic.

16. The plug of claim 15, further comprising an optical socket coupled to the optical convertor and configured to receive and transmit optical signals via a connected optical fiber.

17. The plug of claim 2, wherein the memory controller detects a second network device coupled to a universal serial bus (“USB”) socket via a USB connector.

18. A quad small form-factor pluggable (“QSFP) plug for storing data and transmitting data traffic, comprising:
an Ethernet connector configured to be pluggable to an Ethernet socket situated at a first network system for data transmission;
a non-volatile memory (“NVM”) storage coupled to the Ethernet connector and configured to store information persistently;
a wireless universal serial bus (“USB”) manager coupled to the NVM storage and configured to handle data formatted in wireless protocol and capable of facilitating data transmitting to the Ethernet connector; and
a memory controller coupled to the Ethernet connector and configured to forward the data traffic from the Ethernet connector to the NVM storage or the USB manager in response to control signals in header of the data traffic.

19. The plug of claim 18, further comprising a USB socket coupled to the USB manager and configured to receive and transmit wireless signals via a wireless transceiver connected to the USB socket.

20. The plug of claim 18, wherein the USB manager includes a wireless transceiver capable of transmitting wireless signals via an onboard channel.

21. A method for storing data and transmitting data traffic, comprising:
inserting a small form-factor pluggable (“SFP”) auxiliary plug (“SAP”) into an Ethernet socket a network system for data transmission;
receiving a data stream from the network system via the Ethernet socket;
extracting a header portion of the data stream to identify destination of the data stream;
storing at least a portion of the data stream in a local non-volatile memory (“NVM”) storage if the destination of the data stream indicates NVM storage; and
forwarding at least a portion of the data stream to an output port of SAP if the destination of the data stream indicates network communication.

22. The method of claim 21, further comprising converting the data stream from universal serial bus (“USB”) protocol to Ethernet protocol.

23. The method of claim 21, further comprising plugging an optical cable to an auxiliary connector of the SAP for receiving and transmitting optical signals.
